(19) United States
(12) Patent Application Publication
(10) Pub. No.: US 2024/0085180 A1
(43) Pub. Date: Mar. 14, 2024

(54) OPTICAL FIBER SENSING SYSTEM AND EVENT IDENTIFICATION METHOD

(71) Applicant: NEC Corporation, Minato-ku, Tokyo (JP)

(72) Inventors: Yutaka YANO, Tokyo (JP); Eitaro MISUMI, Tokyo (JP)

(73) Assignee: NEC Corporation, Minato-ku, Tokyo (JP)

(21) Appl. No.: 17/767,509

(22) PCT Filed: Aug. 20, 2020
(86) PCT No.: PCT/JP2020/031364

§ 371 Date: Apr. 8, 2022

(30) Foreign Application Priority Data
Oct. 18, 2019 (JP) 2019-191494

(51) Int. Cl. G01C 13/00

(52) U.S. Cl. CPC G01C 13/004

(57) ABSTRACT

An optical fiber sensing system according to the present disclosure includes: an optical fiber (11) configured to sense water pressure change caused by an event that has occurred in an observation region, the optical fiber being disposed in water; a reception unit (20) configured to receive a light signal from the optical fiber (11); and an identification unit (30) configured to detect distribution of water pressure and time fluctuation of water pressure in the observation region based on a pattern of the light signal, and to identify an event that has occurred in the observation region based on the detection result.

### TECHNICAL FIELD

The present disclosure relates to an optical fiber sensing system and an event identification method.

### BACKGROUND ART

There is a need to observe events that occur in water areas such as seas, rivers, lakes and dams. Some events that occur in a water area change water pressure that affects underwater. As an event that changes water pressure, a tsunami which occurs in the sea, can be mentioned.

As a technique for observing waves on a water surface, an ultrasonic wave-height meter or a GPS (Global Positioning System) wave gauge is generally used. In addition, a method of observing water pressure change on the seafloor, which is caused by waves, with a water pressure sensor placed on the seafloor is also generally used. This method is used especially for sensing and warning a tsunami at offshore (Patent Literature 1). Since, with this method, one measuring instrument can observe only one place, a wide sea area is covered by installing multiple measuring instruments.

Further, Patent Literature 2 discloses a technique for detecting water pressure due to a tsunami using an optical fiber. According to the technique disclosed in Patent Literature 2, by laying a plurality of optical fibers having different lengths on the seafloor and detecting a phase change of the propagating light propagated through the optical fiber, change of water pressure over a wide sea area is detected and a tsunami is observed from the change of water pressure and the time of the change.

### CITATION LIST

### Patent Literature

[Patent Literature 1] U.S. Pat. No. 7,289,907
[Patent Literature 2] Japanese Unexamined Patent Application Publication No. H08-128869

### SUMMARY OF INVENTION

### Technical Problem

However, technologies for observing the above described events using an ultrasonic wave-height meter, a GPS wave gauge, and a water pressure sensor placed on the seafloor require electrical wiring and cause up-sizing of apparatuses. Therefore, there are problems in durability of the apparatuses, and further, the maintenance work becomes complicated so that the cost becomes expensive. Thus, it is necessary to install multiple high-cost observation apparatuses to cover a wide sea area.

Further, the method disclosed in Patent Literature 2 for detecting the effect of the water pressure change, to which the undersea cable is subjected, by assembling a huge optical interferometer also needs to construct a large number of huge optical interferometers to know the water pressure change for each section of the undersea cable so that many core wires are required and economic efficiency is impaired.

Meanwhile, as an event that changes water pressure in the sea, not only the above described tsunami but also sea waves, tides, movement of ships and the like can be considered. In addition, an event that changes water pressure may possibly occur in rivers and dams.

In order to observe various events occurring in such water areas, it was economically disadvantageous to use the technology for tsunami sensing as disclosed in Patent Literature 1 and Patent Literature 2.

Accordingly, it is an object of the present disclosure to provide an optical fiber sensing system and an event identification method, which solve any of the above described problems.

### Solution to Problem

An optical fiber sensing system according to one aspect includes;
an optical fiber configured to sense water pressure change caused by an event that has occurred in an observation region, the optical fiber being disposed in water;
a reception unit configured to receive a light signal from the optical fiber; and
an identification unit configured to detect distribution of water pressure and time fluctuation of water pressure in the observation region based on a pattern of the light signal, and to identify an event that has occurred in the observation region based on the detection result.

An event identification method according to one aspect is an event identification method by an optical fiber sensing system, the event identification method including:
a reception step of receiving a light signal from an optical fiber configured to sense water pressure change caused by an event that has occurred in an observation region, the optical fiber being disposed in water; and
an identification step of detecting distribution of water pressure and time fluctuation of water pressure in the observation region based on a pattern of the light signal, and identifying an event that has occurred in the observation region based on the detection result.

### Advantageous Effects of Invention

According to the above-described aspect, it is possible to obtain an effect of providing an optical fiber sensing system and an event identification method, which are capable of observing various events occurring in water areas.

### BRIEF DESCRIPTION OF DRAWINGS

FIG. 1 is a diagram to show a configuration example of an optical fiber sensing system according to a first example embodiment.

FIG. 2 is a diagram to show an example in which change of water pressure due to waves is detected.

FIG. 3 is a diagram to show an example of graph in which part of the water pressure change of FIG. 2 is taken out and graphed.

FIG. 4 is a diagram to show an example in which change of water pressure due to a wake of a ship.

FIG. 5 is a diagram to show an example in which change of water pressure due to a wake of a ship.

FIG. 6 is a diagram to show an example in which change of water pressure due to a wake of a ship.

FIG. 7 is a diagram to show an example in which change of water pressure due to a wake of a ship.

FIG. 8 is a diagram to show an example in which change of water pressure due to wave is detected.

FIG. 9 is a flow diagram to show a general operation flow of an optical fiber sensing system according to a first example embodiment.

FIG. 10 is a flow diagram to show a general operation flow of an optical fiber sensing system according to a second example embodiment.

FIG. 11 is a flow diagram to show a general operation flow of an optical fiber sensing system according to a third example embodiment.

FIG. 12 is a flow diagram to show a general operation flow of an optical fiber sensing system according to a fourth example embodiment.

FIG. 13 is a diagram to show an example of a laying method of an optical fiber cable according to each example embodiment.

FIG. 14 is a diagram to show an example of a laying method of an optical fiber cable according to each example embodiment.

FIG. 15 is a diagram to show an example of a laying method of an optical fiber cable according to each example embodiment.

FIG. 16 is a block diagram to show a hardware configuration of a computer for implementing an optical fiber sensing instrument.

### DESCRIPTION OF EMBODIMENTS

Hereinafter, example embodiments of the present disclosure will be described with reference to the drawings. The following descriptions and drawings have been omitted or simplified as appropriate for the sake of clarity of explanation. Moreover, in each of the following drawings, like elements are designated by the same reference numeral, and duplicate explanations are omitted as necessary.

### First Example Embodiment

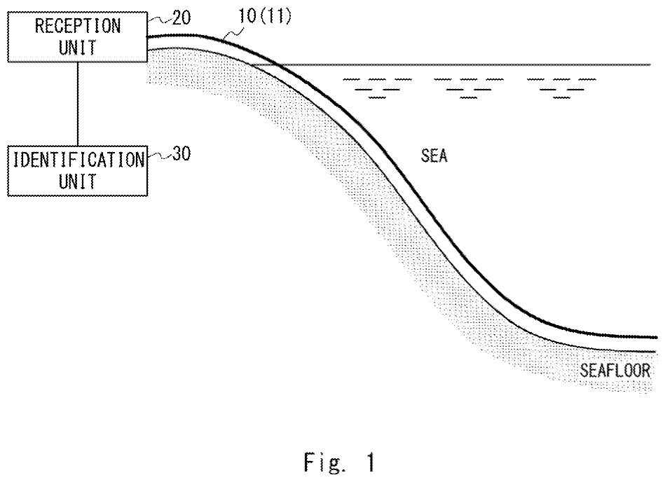

First, a configuration example of an optical fiber sensing system according to a first example embodiment will be described with reference to FIG. 1.

As shown in FIG. 1, the optical fiber sensing system according to the first example embodiment includes an optical fiber cable 10, a reception unit 20, and an identification unit 30.

The optical fiber cable 10 includes at least one optical fiber 11. For example, the optical fiber cable 10 may have a structure in which the optical fiber 11 is held and passed through inside a long tube.

Further, the optical fiber cable 10 may be an existing optical fiber cable. At this time, if there is an unused optical fiber (so-called dark fiber) among the optical fibers included in the existing optical fiber cable, the unused optical fiber may be used as the optical fiber 11.

Further, the optical fiber cable 10 is disposed in water. More specifically, the optical fiber cable 10 is laid in a water area such as a sea, a river, a lake, a dam, or the like, which is an observation region. FIG. 1 shows an example of the laying method when the observation region is a sea, as an example of the laying method of the optical fiber cable 10. In FIG. 1, the optical fiber cable 10 is laid in the sea as an undersea cable connecting continents, and extends from shore to offshore.

Further, although only one optical fiber cable 10 is provided in FIG. 1, a plurality of optical fiber cables 10 may be provided. When a plurality of optical fiber cables 10 are provided, the plurality of optical fiber cables 10 are connected to the reception unit 20 and the identification unit 30.

The reception unit 20 causes a pulsed light to enter the optical fiber 11 constituting the optical fiber cable 10, as incident light. Further, the reception unit 20 receives backscattered light (light signal) that has occurred at each point on the optical fiber 11 as the pulsed light is transmitted through the optical fiber 11.

Here, when an event that changes water pressure occurs in an observation region, change of water pressure occurs, and the change of water pressure is transferred to the optical fiber 11 constituting the optical fiber cable 10 so that change of vibration or acoustics occurs at each point on the optical fiber 11. This change of vibration or acoustics appears in Rayleigh scattered light among the backscattered light which has occurred at each point on the optical fiber 11. Therefore, the optical fiber 11 can sense change of water pressure.

Further, since the change of vibration or acoustics at each point on the optical fiber 11 appears in Rayleigh scattered light among the backscattered light which has occurred at each point on the optical fiber 11, this Rayleigh scattered light includes a pattern (acoustic pattern or vibration pattern) that dynamically changes in response to change of vibration or acoustics. Therefore, by analyzing the pattern of the Rayleigh scattered light among the backscattered light which has occurred at each point on the optical fiber 11, it is possible to detect the change of vibration or acoustics at each point on the optical fiber 11.

Further, any change of vibration or acoustics at each point on the optical fiber 11 has occurred caused by change of water pressure. Therefore, it is also possible to detect distribution of water pressure and time fluctuation of water pressure by analyzing the change of vibration or acoustics at each point on the optical fiber 11.

Then, the identification unit 30 detects the distribution of water pressure and the time fluctuation of water pressure by detecting the change of vibration or acoustics at each point on the optical fiber 11 based on the pattern of the Rayleigh scattered light among the backscattered light which has occurred at each point on the optical fiber 11. The identification unit 30 can identify the position on the optical fiber 11 at which the backscattered light has occurred (a cable length of the optical fiber cable 10 from the reception unit 20) based on, for example, a time difference between the time when the reception unit 20 caused a pulsed light to enter the optical fiber 11, and the time when the reception unit 20 received the backscattered light from the optical fiber 11.

Moreover, the change of water pressure has occurred caused by an event that has occurred in the observation region. For example, the distribution of water pressure and the time fluctuation of water pressure when an event such as a tsunami, a sea wave, and a tide occurs will become a distribution and time fluctuation peculiar to those events. Therefore, by analyzing the distribution of water pressure and the time fluctuation of water pressure, it is possible to identify the event that has occurred in the observation region.

Therefore, the identification unit 30 further identifies an event that has occurred in the observation region based on the detection results of the distribution of water pressure and the time fluctuation of the water pressure. Events that have occurred in the observation region are, for example, tsunamis, sea waves, tides, movement of ships, and the like.

The distribution of water pressure and the time fluctuation of water pressure modulate the Rayleigh scattered light among the backscattered light. As a technique for detecting modulated Rayleigh scattered light, DAS (Distributed Acoustic Sensor) or DVS (Distributed Vibration Sensor) is suitable.

Both DAS and DVS are techniques for detecting phase-modulated Rayleigh scattered light.

Of these, DAS performs coherent detection. That is, the DAS makes the Rayleigh scattered light interfere with locally emitted light to detect phase rotation of Rayleigh reflected light.

On the other hand, DVS detects instantaneous power of Rayleigh scattered light. That is, in the optical fiber 11, the phase-modulated Rayleigh scattered light undergoes multiple interference and is converted into intensity-modulated light, so that DVS detects the intensity-modulated light.

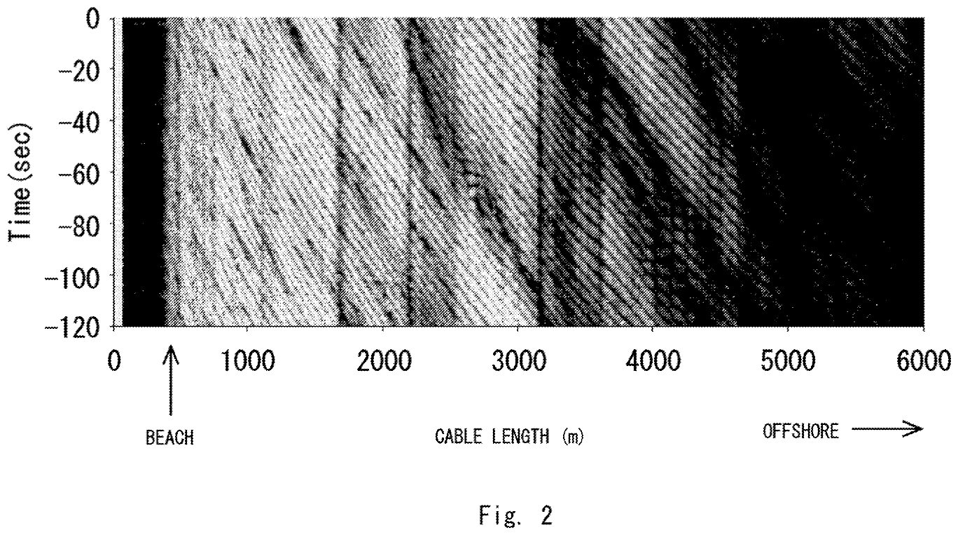

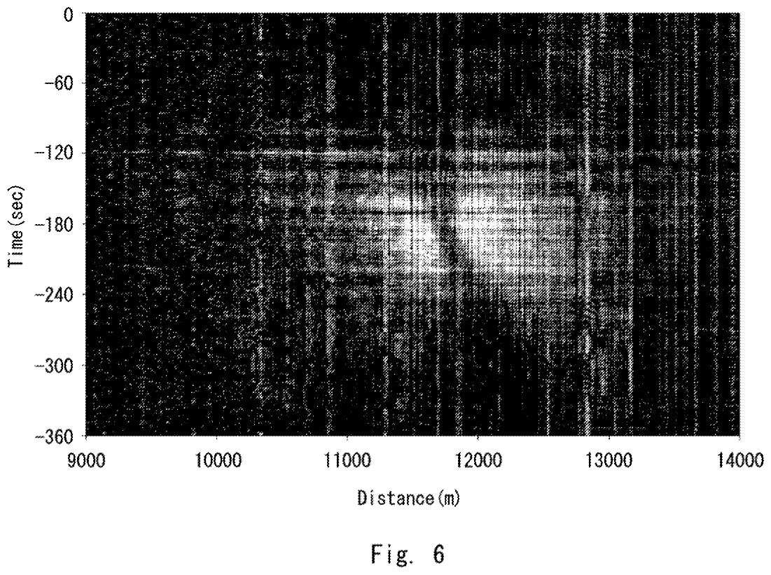

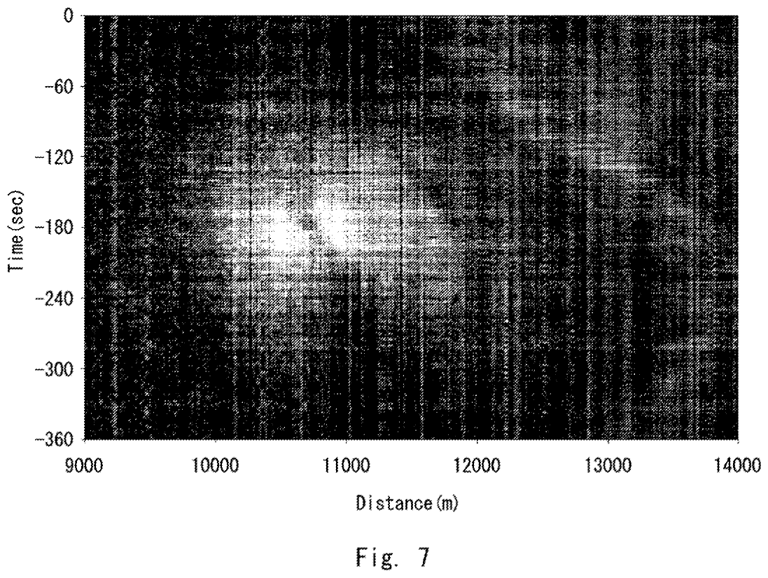

Hereinafter, as an example, a method of identifying an event that has occurred in the observation region by using DAS in the identification unit 30 will be described with reference to FIGS. 2 to 7.

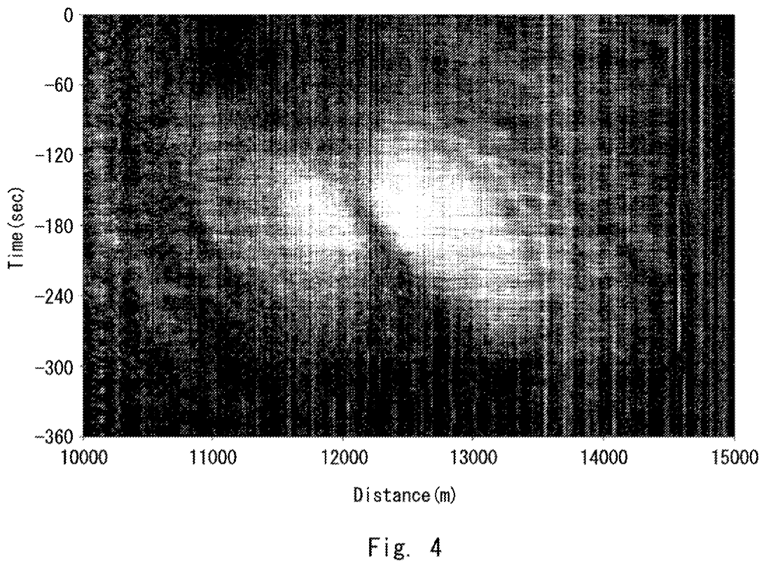

The identification unit 30 uses DAS to acquire a pattern of Rayleigh scattered light representing change of water pressure which has occurred at each point on the optical fiber 11 caused by change of water pressure due to an event which has occurred in the observation region. For example, when processing the backscattered light when change of water pressure due to a sea wave has occurred in the observation region, a pattern as shown in FIG. 2 will be obtained. Further, when processing the backscattered light when change of water pressure due to movement of a ship in the observation region, patterns shown in FIGS. 4 to 7 will be obtained. These patterns represent changes in water pressure at each point on the optical fiber 11. Therefore, the identification unit 30 can detect the distribution of water pressure and the time fluctuation of water pressure in the observation region based on these patterns. Further, the identification unit 30 can identify an event that has occurred in the observation region based on the detection result.

FIG. 2 shows the observation result of water pressure change observed for 2 minutes using DAS in the observation range where the cable length of the optical fiber cable 10 from the reception unit 20 is up to 6 km. Water depth at 6 km offshore is 120 m, which is a shallow seacoast. In FIG. 2, the horizontal axis indicates the cable length [m] of the optical fiber cable 10 from the reception unit 20, the left side is the shore side, and the right side indicates offshore. The vertical axis indicates time [sec], and the time advances toward upward direction. The shade of color indicates the level of water pressure sensed by the cable, and the brighter the color, the higher the water pressure.

In FIG. 2, the height of surface wave propagating in the observation range is represented by brightness and darkness. Positive and negative signs of the slope of the line indicating the surface wave indicates the direction of surface wave, and when the slope is negative, it indicates that the surface wave is heading toward the shore. Moreover, the magnitude of the slope of the line indicating surface wave indicates the speed of surface wave, and the larger the slope, the slower the speed.

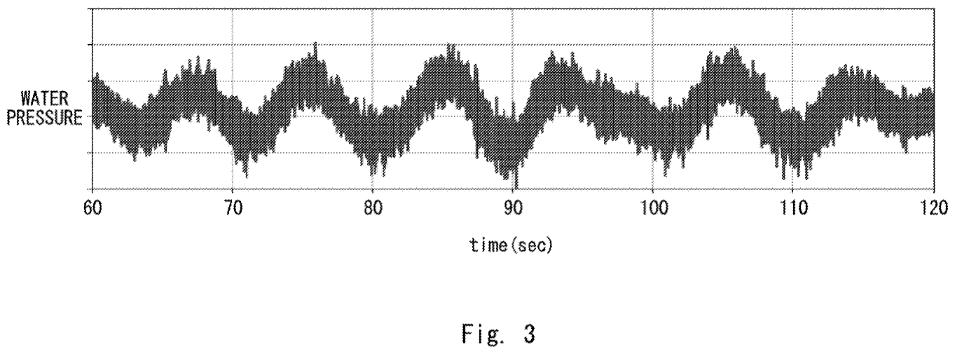

Further, FIG. 3 is a graph in which change of water pressure at a point where the cable length in FIG. 2 is 2.6 km and the water depth is about 50 m is extracted and graphed (not at the same time). In FIG. 2, the horizontal axis indicates time [sec], and the vertical axis indicates the magnitude of water pressure. Therefore, FIG. 3 shows that the period of the surface wave is about 10 seconds. Moreover, the wave height of the surface wave can be estimated from the magnitude of the water pressure in FIG. 3.

Therefore, from FIGS. 2 and 3, properties (traveling direction, velocity, wave height, and period) of a surface wave that has occurred in the observation region can be known. Here, for example, a property of a surface wave when an event such as a tsunami, a sea wave, and a tide has occurred will be a property peculiar to such an event. Therefore, by analyzing the property of the surface wave that has occurred in the observation region, it is possible to identify events such as a tsunami, a sea wave, a tide, that has occurred in the observation region. Then, the identification unit 30 identifies the property of surface wave based on detection results of the distribution of water pressure and the time fluctuation of water pressure shown in FIG. 2, and further, based on the identification results, a tsunami, a sea wave, a tide, and the like are identified as an event that has occurred in the observation region.

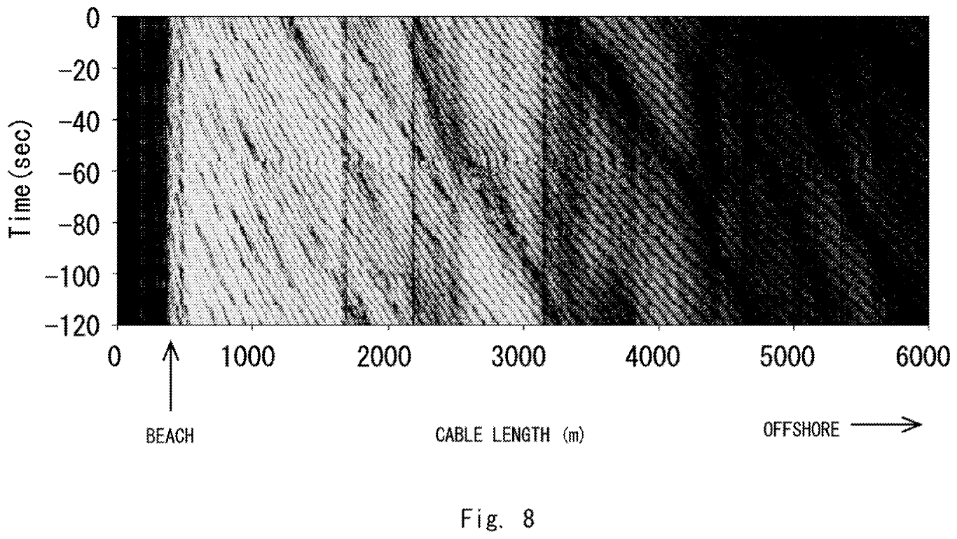

Note that a similar pattern as in FIG. 2 can also be obtained by using DVS. FIG. 8 shows a detection result by DVS of a surface wave substantially at the same place and the same time in an undersea cable installed side by side with that of FIG. 2. It can be seen that the wave is detected in the same way by either detection method.

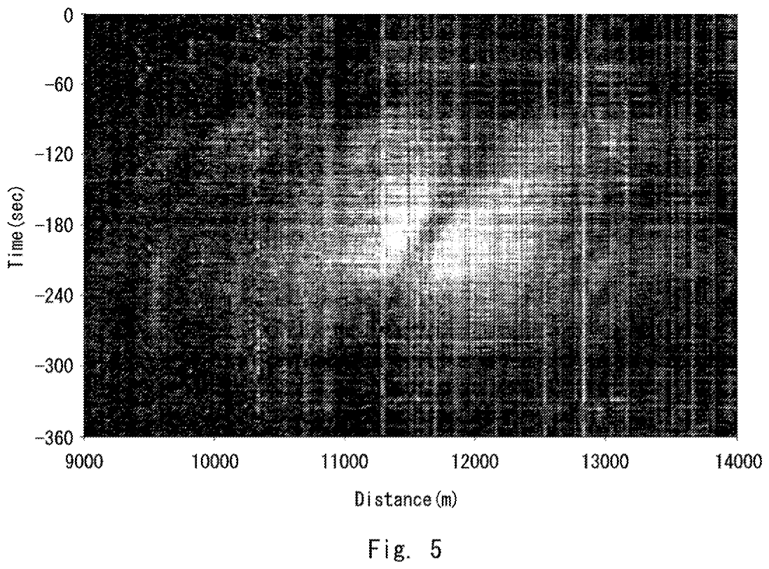

FIG. 4 shows an observation result of water pressure change observed for over 6 minutes using DAS in an observation region where the cable length of the optical fiber cable 10 from the reception unit 20 is from 10 km to 15 km. Similarly, FIGS. 5 to 7 each show an observation result of water pressure change observed for over 6 minutes using DAS in an observation region where the cable length is from 9 km to 14 km. Note that FIGS. 4 to 7 each show an observation result in a different time zone. Moreover, in FIGS. 4 to 7, the horizontal axis, the vertical axis, and the shade of color are the same as those in FIG. 2.

When a ship moves in the observation region, a ship wake occurs on each of the port side and the starboard side of the ship as the ship moves. In FIGS. 4 to 7, a substantially elliptical portion having higher water pressure (brighter color) indicates a ship wake, and a pair of two ship wakes indicates one ship. Further, FIGS. 4 to 7 show that one ship is crossing the optical fiber cable 10.

Therefore, the identification unit 30 identifies the movement of a ship as an event that has occurred in the observation region based on the detection results of the distribution of water pressure and the time fluctuation of water pressure shown in FIGS. 4 to 7.

Moreover, when a ship is moving in a situation where a sea wave, etc. is occurring in the observation region, a pattern caused by a wave such as a sea wave, and a pattern caused by the movement of a ship may appear at the same time in the Rayleigh scattered light. In this case, the identification unit 30 may eliminate one pattern and identify an event based on the other pattern, and may successively eliminate the other pattern and identify an event based on the one pattern.

Moreover, for each event that occurs in the observation region, there is a frequency peculiar to that event. Therefore, having acquired a pattern of Rayleigh scattered light caused by a certain event, the identification unit 30 may perform FFT (Fast Fourier Transform) on the pattern at a frequency peculiar to the event, thereby enabling to obtain a more detailed pattern regarding the event. For example, when the event is a sea wave, the identification unit 30 may perform FFT on the Rayleigh scattered light pattern shown in FIGS. 2, 3, and 8 at a frequency peculiar to the sea wave, thereby enabling to obtain a more detailed pattern for the sea wave. Therefore, the identification unit 30 can obtain more detailed information about the sea wave based on the more detailed pattern about the sea wave.

Further, in the above description, with reference to FIGS. 2 to 8, a method of identifying an event which has occurred in the observation region by using DAS or DVS in the identification unit 30 has been described, but these methods are merely examples, and the present disclosure will not be limited thereto. For example, an event that has occurred in an observation region may be identified by using pattern matching, or using a learning model which is machine learned (for example, deep learned) by supervised learning.

For example, when using pattern matching, the identification unit 30 keeps in advance a pattern of Rayleigh scattered light when the event has occurred, as a pattern for matching for each event to be observed. Upon acquiring a pattern of Rayleigh scattered light, the identification unit 30 compares the acquired pattern of Rayleigh scattered light with the pattern for matching. If, in the patterns for matching, there is a pattern for matching whose matching rate with the pattern of Rayleigh scattered light is equal to or greater than a threshold value, the identification unit 30 determines that the event corresponding to the pattern for matching has occurred.

Further, when using a learning model by machine learning, the identification unit 30 builds and hold a learning model in advance by inputting plural sets of training data indicating a certain event and Rayleigh scattered light pattern when the event has occurred. Upon acquiring a pattern of Rayleigh scattered light, the identification unit 30 inputs the acquired pattern of Rayleigh scattered light to the learning model. As a result, the identification unit 30 obtains an event that has occurred in the observation region as an output result of the learning model.

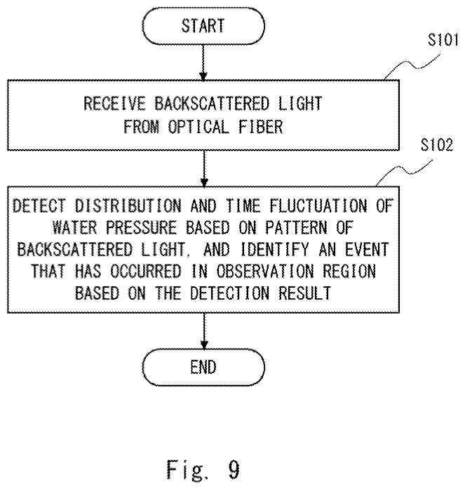

Subsequently, with reference to FIG. 9, an example of the general operation flow of an optical fiber sensing system according to a first example embodiment will be described.

As shown in FIG. 9, the reception unit 20 receives backscattered light from the optical fiber 11 constituting the optical fiber cable 10 disposed in a water area to be the observation region (step S101).

Subsequently, the identification unit 30 detects the distribution of water pressure and the time fluctuation of water pressure in the observation region based on the pattern of Rayleigh scattered light among the backscattered light, and based on the detection result, identifies the event that has occurred in the observation region (Step S102).

As described above, according to the first example embodiment, the reception unit 20 receives the backscattered light from the optical fiber 11 disposed in water in the observation region. The identification unit 30 detects the distribution of water pressure and the time fluctuation of water pressure in the observation region based on the pattern of Rayleigh scattered light among the backscattered light, and based on the detection result, identifies the event that has occurred in the observation region. Therefore, it is possible to observe various events, without being limited to tsunamis, as events that occur in a water area to be observed.

### Second Example Embodiment

The second example embodiment is an example in which subsequent operation is added when a tsunami or a sea wave is identified as an event that has occurred in the observation region, in the first example embodiment described above. Note that the configuration itself of the second example embodiment is the same as that of the first example embodiment described above.

As described above, the identification unit 30 can identify a property (traveling direction, velocity, wave height, or period) of a surface wave that has occurred in the observation region, for example, from detection results of the distribution of water pressure and the time fluctuation of water pressure in the observation region shown in FIGS. 2 and 8. Therefore, when the event that has occurred in the observation region is a tsunami or a sea wave, the identification unit 30 can identify the property of the tsunami or the sea wave.

Then, the identification unit 30 predicts the time when the tsunami or the sea wave arrives at or passes through a predetermined point and the wave height when the tsunami or the sea wave has arrived at or passed through a predetermined point based on the property of the tsunami or the sea wave. The point where the tsunami or the sea wave arrives is a land point, and the point where the tsunami or the sea wave passes through is a water area.

For example, the identification unit 30 keeps the correspondence between the property of a tsunami or a sea wave at a certain position and at a certain time, and the time and the wave height when the tsunami or the sea wave has actually arrived at or passed through a predetermined point, as statistical data. Then, the identification unit 30 may make the above described prediction based on the statistical data.

Moreover, the identification unit 30 may estimate possibility that the tsunami or the sea wave causes damage at a predetermined point based on the property of the tsunami or the sea wave, and when there is a possibility of causing damage, may further estimate the level of damage.

For example, the identification unit 30 keeps correspondence between a property of a tsunami or a sea wave at a certain point, the presence or absence of damage actually caused by the tsunami or the sea wave at a predetermined land point and a predetermined water area, and if there is damage, the level of damage, as statistical data. Then, the identification unit 30 may perform the above described estimation based on the statistical data.

Further, the identification unit 30 may notify the above described prediction result and the above described estimation result to a predetermined notification destination. For example, when the predetermined point is a land point at which a tsunami or a sea wave arrives, the predetermined notification destination may be considered to be the national government, local governments, fishery, travel ships, or the like. On the other hand, when the predetermined point is a water area through which a tsunami or a sea wave passes, the predetermined notification destination may be fishery, travel ships, work vehicles working in the water area, surfers, fishing visitors, or the like. The predetermined notification destination may be limited to a notification destination registered in the system in advance to receive notification.

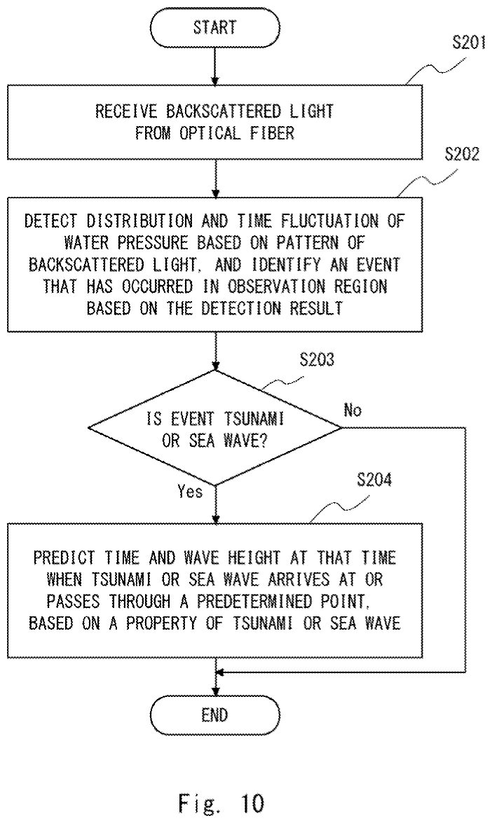

Subsequently, with reference to FIG. 10, an example of the overall operation flow of the optical fiber sensing system according to the second example embodiment will be described.

As shown in FIG. 10, first, steps S201 and S202, which are the same as steps S101 and S102 in FIG. 9, are performed.

If the event identified in step S202 is a tsunami or a sea wave (Yes in step S203), then the identification unit 30 predicts the time when the tsunami or the sea wave arrives at or passes through a predetermined point, and the wave height at the time of arrival or passing based on the property of the tsunami or the sea wave (step S204).

Note that the identification unit 30 may estimate possibility that the tsunami or the sea wave causes damage to a predetermined point, based on the property of the tsunami or the sea wave, and may further estimate the level of damage when there is a possibility of causing damage. Further, the identification unit 30 may notify the above described prediction result and the above described estimation result to a predetermined notification destination.

As described above, according to the second example embodiment, the identification unit 30 predicts the time when a tsunami or a sea wave arrives at or passes through a predetermined point, which includes points other than those directly above the optical fiber cable 10, and the wave height at the time of arrival or passing of the tsunami or the sea wave. Therefore, it is possible not only to observe a tsunami or a sea wave that has occurred in a water area to be observed, but also to obtain prediction results of the time when the tsunami or the sea wave arrives or passes, and the wave height at that time.

Other effects are the same as those in the first example embodiment described above.

### Third Example Embodiment

A third example embodiment is an example in which a subsequent operation is added when movement of a ship is identified as the event that has occurred in the observation region in the first example embodiment described above. The configuration itself of the third example embodiment is the same as that of the first example embodiment described above.

The identification unit 30 can identify, for example, the number and position of ships moving in an observation region from the detection results of the distribution of water pressure and the time fluctuation of water pressure in the observation region shown in FIGS. 4 to 7. Further, the traveling direction of the ship can be known from the direction of the gap between the two ship wakes representing one ship. In addition, the speed of one ship can be known from the time fluctuation of two ship wakes representing the ship. Therefore, the identification unit 30 can identify the state (speed, traveling direction, position, number) of the ship moving in the observation region from the detection results of the distribution of water pressure and the time fluctuation of water pressure in the observation region shown in FIGS. 4 to 7.

Then, the identification unit 30 detects that the ship has invaded a predetermined region or may possibly invade a predetermined region based on the state of the ship. The predetermined region includes, for example, territorial waters, fishing grounds, and the like.

Moreover, the identification unit 30 may be able to wirelessly receive position data information indicating at least the position of a ship traveling on the sea. For example, from a ship equipped with an AIS (Automatic Identification System), position data information indicating the position, movement status, destination, etc. of the ship can be wirelessly received. In that case, the identification unit 30 may identify a ship that has invaded a predetermined region or a ship that may possibly invade a predetermined region based on the position data information of the ship. For example, if the identification unit 30 has position data information indicating the same position as the position of the ship identified from the detection results of the distribution of water pressure and the time fluctuation of water pressure in the observation region, the identification unit 30 identifies the ship indicated by the position data information as a ship that has invaded the region or a ship that may possibly invade the predetermined region.

Further, when detecting that the ship has invaded a predetermined region or may possibly invade a predetermined region, the identification unit 30 may notify the detection result to a predetermined notification destination. For example, if the predetermined region is a territorial water, a country can be considered as the predetermined notification destination. When the predetermined region is a fishing ground, a fisherman working in the fishing ground can be considered as the predetermined notification destination. The predetermined notification destination may be limited to a notification destination registered in the system in advance to receive notification.

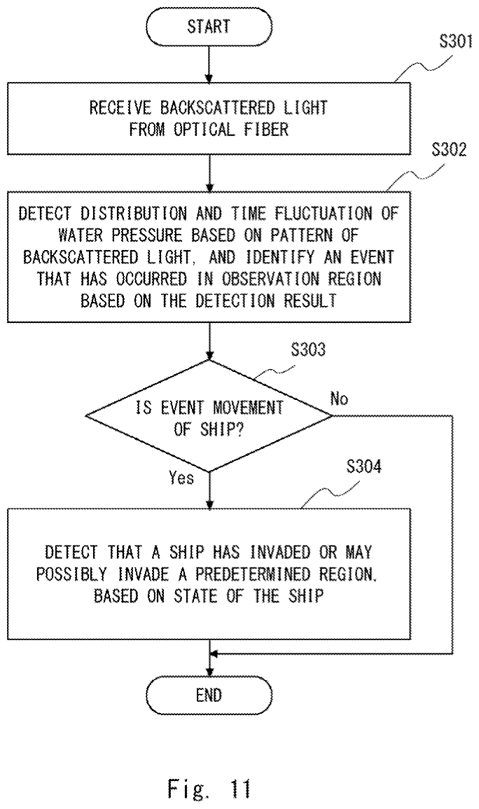

Next, with reference to FIG. 11, an example of general operation flow of an optical fiber sensing system according to the third example embodiment will be described.

As shown in FIG. 11, first, steps S301 and S302, which are the same as steps S101 and S102 of FIG. 9, are performed.

When the event identified in step S302 is movement of a ship (Yes in step S303), subsequently, the identification unit 30 detects that the ship has invaded a predetermined region or may possibly invade a predetermined region based on the state of the ship (step S304).

Note that when position data information of ships traveling on the sea can be received wirelessly, the identification unit 30 may identify a ship that has invaded the region or a ship that may possibly invade the predetermined region by using the position data information. Further, when detecting that the ship has invaded a predetermined region or may possibly invade a predetermined region, the identification unit 30 may notify the detection result to a predetermined notification destination.

As described above, according to the third example embodiment, the identification unit 30 detects that a ship has invaded a predetermined region or may possibly invade a predetermined region based on the state of the ship. Therefore, it is possible not only to observe that a ship is moving in a water area to be observed, but also to observe that the ship has invaded a predetermined region or may possibly invade a predetermined region.

Other effects are the same as those in the first example embodiment described above.

### Fourth Example Embodiment

A fourth example embodiment is an example in which a subsequent operation is added when a tide is identified as the event that has occurred in the observation region in the first example embodiment described above. The configuration itself of the fourth example embodiment is the same as that of the first example embodiment described above.

As described above, the identification unit 30 can identify a property (traveling direction, velocity, wave height, or period) of a surface wave that has occurred in the observation region from detection results of the distribution of water pressure and the time fluctuation of water pressure in the observation region shown in FIGS. 2 and 8.

The property of a tide is characteristic in that a tide has a longer period compared to a tsunami and a sea wave. Therefore, the identification unit 30 can identify that an event that has occurred in the observation region is a tide based on the period of surface wave.

Moreover, a tide may behave differently from a normal tide. For example, when a high tide or a rapid tide is occurring, it behaves differently from a normal tide. At this time, whether or not the behavior of a tide is different from that of a normal tide can be determined from the pattern of Rayleigh scattered light among the backscattered light that has occurred at each point on the optical fiber 11.

Then, the identification unit 30 detects that a high tide or a rapid tide is occurring based on the pattern of the Rayleigh scattered light among the backscattered light that has occurred at each point on the optical fiber 11.

At this time, the identification unit 30 may detect that a high tide or a rapid tide is occurring by using, for example, pattern matching.

When pattern matching is used, for example, the identification unit 30 keeps in advance a pattern of Rayleigh scattered light when a normal tide has occurred, as a pattern for matching. When identifying that an event that has occurred in the observation region is a tide, the identification unit 30 compares the pattern of Rayleigh scattered light at that time with the pattern for matching. When there is no pattern for matching whose matching rate with the pattern of Rayleigh scattered light is equal to or greater than a threshold value, in the patterns for matching, the identification unit 30 determines that a high tide or a rapid tide has occurred.

Note that in the fourth example embodiment, the identification unit 30 needs to analyze the pattern of Rayleigh scattered light caused by a tide in detail. Therefore, the identification unit 30 preferably acquires a more detailed pattern regarding a tide by performing FFT on the pattern of Rayleigh scattered light caused by a tide at a frequency peculiar to the tide, and based on the detailed pattern, may detect a high tide or a rapid tide.

Moreover, upon detecting a high tide or a rapid tide, the identification unit 30 may notify the detection result to a predetermined notification destination. For example, the predetermined notification destination may be the national government, local governments, fishery, travel ships, surfers, fishing visitors, and the like. Note that the predetermined notification destination may be limited to a notification destination registered in the system in advance to receive the notification.

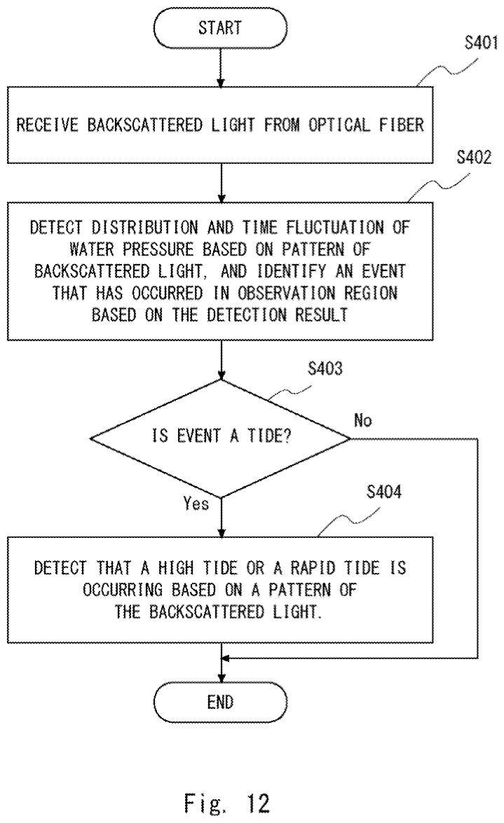

Next, with reference to FIG. 12, an example of general operation flow of the optical fiber sensing system according to the fourth example embodiment will be described.

As shown in FIG. 12, first, steps S401 and S402, which are the same as steps S101 and S102 in FIG. 9, are performed.

When the event identified in step S402 is a tide (Yes in step S403), the identification unit 30 detects that a high tide or a rapid tide is occurring based on the pattern of Rayleigh scattered light among the backscattered light that has occurred at each point on the optical fiber 11 (step S404).

When detecting that a high tide or a rapid tide is occurring, the identification unit 30 may notify the detection result to a predetermined notification destination.

As described above, according to the fourth example embodiment, the identification unit 30 detects that a high tide or a rapid tide is occurring based on the pattern of Rayleigh scattered light among the backscattered light that has occurred at each point on the optical fiber 11. Therefore, it is possible not only to observe a tide that has occurred in a water area to be observed, but also to observe that a high tide or a rapid tide is occurring.

Other effects are the same as those in the first example embodiment described above.

### Fifth Example Embodiment

The configuration itself of the fifth example embodiment is the same as that of the first to fourth example embodiments described above.

In the above described first to fourth example embodiments, an event that has occurred in an observation region is identified by utilizing that the pattern of Rayleigh scattered light among the backscattered light fluctuates caused by change of water pressure due to an event that has occurred in an observation region.

However, regardless of the occurrence or nonoccurrence of an event, if the water depth changes, the water pressure will change, and as a result, the pattern of Rayleigh scattered light will also change. Therefore, it is possible to detect the water depth in the observation region by analyzing the pattern of Rayleigh scattered light among the backscattered light that has occurred at each point on the optical fiber 11.

Then, the identification unit 30 detects the water depth in the observation region based on the pattern of Rayleigh scattered light among the backscattered light that has occurred at each point on the optical fiber 11.

Note that the identification unit 30 can also detect change of water depth in the observation region by detecting the water depth in the observation region regularly or irregularly.

For example, in a river and a dam, when flooding occurs, the water depth increases. Therefore, the identification unit 30 may detect that flooding has occurred based on whether or not the water depth has increased in a river or a dam.

Moreover, in the sea, if crustal movement of seafloor occurs, the seafloor rises or subsides, and thus the water depth changes. For example, when the seafloor rises, the water depth decreases. Therefore, the identification unit 30 may detect that crustal movement of the seafloor has occurred based on whether or not the water depth has changed in the sea.

Moreover, upon detecting that flooding has occurred in a river or a dam or that crustal movement on the seafloor has occurred, the identification unit 30 may notify the detection result to a predetermined notification destination. For example, as the predetermined notification destination, the national government, local governments, or the like is considered. Note that the predetermined notification destination may be limited to a notification destination registered in the system in advance to receive the notification.

As described above, according to the fifth example embodiment, the identification unit 30 detects the water depth in an observation region based on the pattern of Rayleigh scattered light among the backscattered light that has occurred at each point on the optical fiber 11. Therefore, it is also possible to observe the water depth in the observation region. Moreover, from changes of water depth in the observation region, it is possible to observe flooding in rivers and dams and crustal movement of the seafloor in the sea.

Other effects are the same as those in the first example embodiment described above.

### Other Example Embodiments

In each example embodiment described above, the identification unit 30 identifies a position on the optical fiber 11 where backward scattered light has occurred (the cable length of the optical fiber cable 10 from the reception unit 20) based on the time difference between the time when the reception unit 20 caused a pulsed light to enter the optical fiber 11 and the time when the reception unit 20 receives backward scattered light from the optical fiber 11. However, the correspondence between a position represented by the latitude/longitude coordinate system and a position on the optical fiber 11 is estimation from the laying route information and has an error.

Therefore, it is preferable to calibrate the relationship between the position on the optical fiber 11 and the actual position. For example, the reception unit 20 and the identification unit 30 are temporarily connected to the optical fiber cable 10, and the optical fiber cable 10 is hit or touched to generate vibration or sound in the optical fiber cable 10, to identify the position on the fiber 11 at that time. Nowadays, the actual position can be accurately grasped even if on ocean by receiving the GNSS (Global Navigation Satellite System) satellite radio wave, and therefore the correspondence between the identified position on the optical fiber 11 and the actual position can be calibrated. Note that this calibration does not need to be performed at a close interval between points along the optical fiber 11, and the effect of improving the position accuracy can be achieved even if the calibration is performed at a relatively large interval.

Moreover, in each example embodiment described above, it has been assumed that one optical fiber cable 10 is laid linearly, that is, two-dimensionally. From this reason, when the identification unit 30 identifies the traveling direction of a surface wave or a ship, the traveling direction can be identified with high accuracy only when the traveling direction is along the optical fiber cable 10.

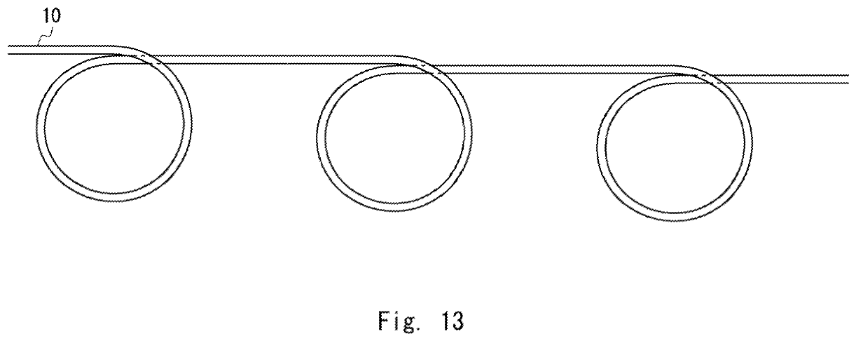

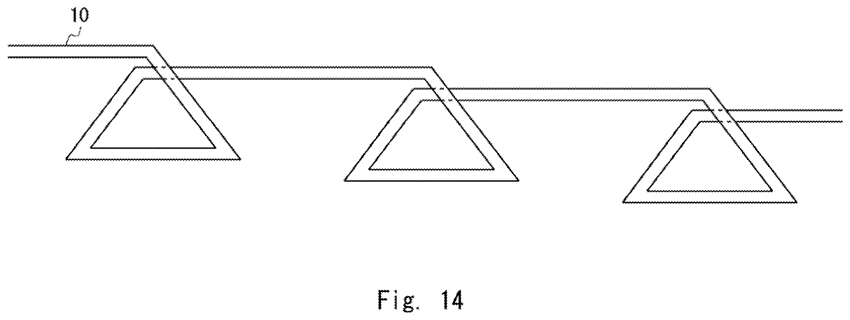

Therefore, when one optical fiber cable 10 is laid, the optical fiber cable 10 may be partially laid in a shape such as a circle, a triangle, or a square. As a result, the optical fiber cable 10 is laid three-dimensionally, so that the traveling direction of a surface wave and a ship can be identified with high accuracy. FIG. 13 shows an example in which the optical fiber cable 10 is partially laid in a circular shape, and FIG. 14 shows an example in which the optical fiber cable 10 is partially laid in a triangular shape. The size of the shape of the optical fiber cable 10, which is partially laid, is about half or not more than half of the wavelength of the backscattered light to be detected.

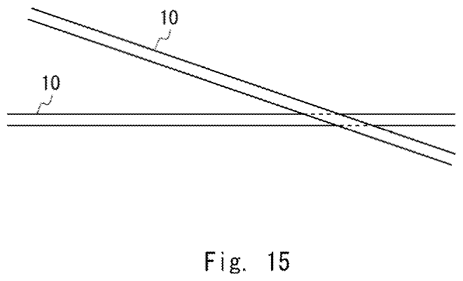

Alternatively, a plurality of optical fiber cables 10 may be laid so as to face different directions from each other. As a result, the optical fiber cable 10 is laid three-dimensionally, so that traveling directions of a surface wave and a ship can be identified with high accuracy. FIG. 15 shows an example in which two optical fiber cables 10 are laid so as to face different directions from each other. The plurality of optical fiber cables 10 may or may not intersect with each other.

Moreover, in the above-described example embodiments, the reception unit 20 and the identification unit 30 are each shown as an independent component in the drawings, but they may be provided in a single apparatus (an optical fiber sensing instrument), or may be provided to be distributed in a plurality of apparatuses.

### <Hardware Configuration of Optical Fiber Sensing Instrument>

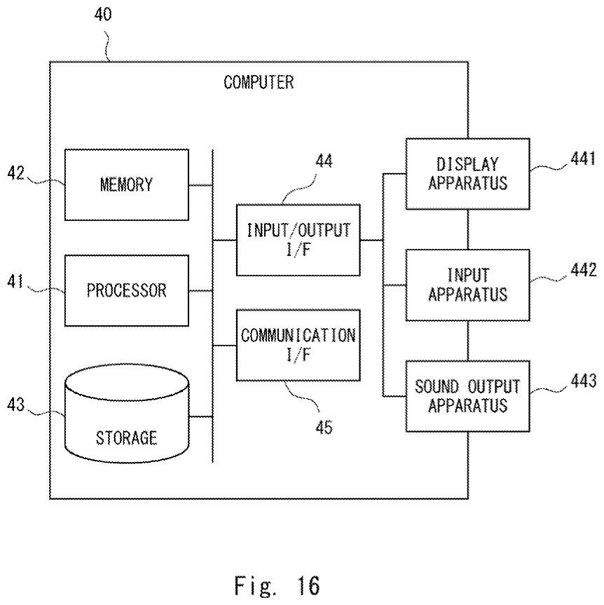

As described above, the reception unit 20 and the identification unit 30 can be provided in a single apparatus (an optical fiber sensing instrument). Then, in the following, with reference to FIG. 16, the hardware configuration of the computer 40 that implements an optical fiber sensing instrument including the reception unit 20 and the identification unit 30 will be described.

As shown in FIG. 16, the computer 40 includes a processor 41, a memory 42, a storage 43, an input/output interface (input/output I/F) 44, a communication interface (communication I/F) 45, and the like. The processor 41, the memory 42, the storage 43, the input/output interface 44, and the communication interface 45 are connected by a data transmission line for transmitting and receiving data to and from each other.

The processor 41 is, for example, an arithmetic processing unit such as a CPU (Central Processing Unit) or a GPU (Graphics Processing Unit). The memory 42 is, for example, a memory such as a RAM (Random Access Memory) or a ROM (Read Only Memory). The storage 43 is, for example, a storage apparatus such as an HDD (Hard Disk Drive), an SSD (Solid State Drive), or a memory card. Moreover, the storage 43 may be a memory such as a RAM or a ROM.

The storage 43 stores a program that implements the functions of the components (reception unit 20 and identification unit 30) included in the optical fiber sensing instrument. By executing each of these programs, the processor 41 implements the functions of the components included in the optical fiber sensing instrument. Here, when executing each of the above described programs, the processor 41 may execute these programs after reading them out on the memory 42, or without reading them out on the memory 42. Further, the memory 42 and the storage 43 also play a role of storing information and data held by the components included in the optical fiber sensing instrument.

Moreover, the above described programs can be stored using various types of non-transitory computer-readable media and supplied to a computer (including the computer 40). The non-transitory computer-readable medium includes various types of tangible storage media. Examples of non-transitory computer-readable medium include magnetic recording media (for example, flexible discs, magnetic tapes, hard disk drives), magneto-optical recording media (for example, magneto-optical discs), CD-ROMs (Compact Disc-ROMs), CD-R (CD-Recordable), CD-R/W (CD-ReWritable), semiconductor memories (for example, mask ROMs, PROMs (Programmable ROMs), EPROMs (Erasable PROMs), flash ROMs, and RAMs). The program may also be supplied to the computer by various types of transitory computer-readable media. Examples of the transitory computer-readable medium include electrical signals, optical signals, and electromagnetic waves. The transitory computer-readable medium can supply the program to the computer via a wired communication path such as an electric wire and an optical fiber, or a wireless communication path.

The input/output interface 44 is connected to a display apparatus 441, an input apparatus 442, a sound output apparatus 443, and the like. The display apparatus 441 is an apparatus that displays a screen corresponding to drawing data processed by the processor 41, such as an LCD (Liquid Crystal Display), a CRT (Cathode Ray Tube) display, and a monitor. The input apparatus 442 is an apparatus that accepts an operator's operation input, and is, for example, a keyboard, a mouse, a touch sensor, and the like. The display apparatus 441 and the input apparatus 442 may be integrated and implemented as a touch panel. The sound output apparatus 443 is an apparatus such as a speaker that acoustically outputs sound corresponding to acoustic data processed by the processor 41.

The communication interface 45 transmits/receives data to/from an external apparatus. For example, the communication interface 45 communicates with an external apparatus via a wired communication path or a wireless communication path.

Although the present disclosure has been described above with reference to the example embodiments, the present disclosure is not limited to the above described example embodiments. Various changes that can be understood by those skilled in the art can be made to the configuration and details of the present disclosure within the scope of the present disclosure.

For example, some or all of the above described example embodiments may be used in combination with each other.

Moreover, some or all of the above described example embodiments may be described as in the supplementary note, but are not limited to the following.

(Supplementary Note 1)

An optical fiber sensing system, comprising:
an optical fiber configured to sense water pressure change caused by an event that has occurred in an observation region, the optical fiber being disposed in water;
a reception unit configured to receive a light signal from the optical fiber; and
an identification unit configured to detect distribution of water pressure and time fluctuation of water pressure in the observation region based on a pattern of the light signal, and to identify an event that has occurred in the observation region based on the detection result.

(Supplementary Note 2)

The optical fiber sensing system according to Supplementary Note 1, wherein
when identifying a tsunami or a sea wave as an event that has occurred in the observation region,
the identification unit
identifies a property of the tsunami or the sea wave based on detection results of distribution of water pressure and time fluctuation of water pressure in the observation region, and
predicts the time when the tsunami or the sea wave arrives at or passes through a predetermined point and the wave height when the tsunami or the sea wave has arrived at or passed through the predetermined point based on the property of the tsunami or the sea wave.

(Supplementary Note 3)

The optical fiber sensing system according to Supplementary Note 2, wherein
the identification unit
notifies prediction results of the time when the tsunami or the sea wave arrives at or passes through the predetermined point, and the wave height when the tsunami or the sea wave has arrived at or passed through the predetermined point, to a predetermined notification destination.

(Supplementary Note 4)

The optical fiber sensing system according to Supplementary Note 2 or 3, wherein
the identification unit
estimates possibility that the tsunami or the sea wave causes damage at the predetermined point based on the property of the tsunami or the sea wave, and when there is a possibility of causing damage, further estimates a level of damage.

(Supplementary Note 5)

The optical fiber sensing system according to Supplementary Note 4, wherein
the identification unit
notifies estimation results of a possibility that the tsunami or the sea wave causes damage to the predetermined point, and the level of damage when there is a possibility of causing damage, to a predetermined notification destination.

(Supplementary Note 6)

The optical fiber sensing system according to Supplementary Note 1, wherein
when identifying movement of a ship as an event that has occurred in the observation region,
the identification unit
identifies a state of the ship based on detection results of distribution of water pressure and time fluctuation of water pressure in the observation region, and
detects that the ship has invaded a predetermined region or may possibly invade the predetermined region based on the state of the ship.

(Supplementary Note 7)

The optical fiber sensing system according to Supplementary Note 6, wherein
the identification unit
wirelessly receives position data information of the ship, and
identifies the ship that has invaded the predetermined region, or the ship that may possibly invade the predetermined region, based on the position data information.

(Supplementary Note 8)

The optical fiber sensing system according to Supplementary Note 6 or 7, wherein
when detecting that the ship has invaded a predetermined region, or may possibly invade the predetermined region,
the identification unit notifies the detection result to a predetermined notification destination.

(Supplementary Note 9)

The optical fiber sensing system according to Supplementary Note 1, wherein
when identifying a tide as an event that has occurred in the observation region,
the identification unit detects that a high tide or a rapid tide is occurring in the observation region based on a pattern of the light signal.

(Supplementary Note 10)

The optical fiber sensing system according to Supplementary Note 9, wherein
when detecting that a high tide or a rapid type is occurring in the observation region,
the identification unit notifies the detection result to a predetermined notification destination.

(Supplementary Note 11)

The optical fiber sensing system according to any one of Supplementary Notes 1 to 10, wherein
the identification unit detects water depth in the observation region based on a pattern of the light signal.

(Supplementary Note 12)

The optical fiber sensing system according to Supplementary Note 11, wherein
the identification unit detects change of water depth in the predetermined region by detecting water depth in the observation region regularly or irregularly.

(Supplementary Note 13)

An event identification method by an optical fiber sensing system, the event identification method comprising:
a reception step of receiving a light signal from an optical fiber configured to sense water pressure change caused by an event that has occurred in an observation region, the optical fiber being disposed in water; and
an identification step of detecting distribution of water pressure and time fluctuation of water pressure in the observation region based on a pattern of the light signal, and identifying an event that has occurred in the observation region based on the detection result.

(Supplementary Note 14)

The event identification method according to Supplementary Note 13, wherein
in the identification step,
when a tsunami or a sea wave is identified as an event that has occurred in the observation region,
a property of the tsunami or the sea wave is identified based on detection results of distribution of water pressure and time fluctuation of water pressure in the observation region, and
time when the tsunami or the sea wave arrives at or passes through a predetermined point, and wave height when the tsunami or the sea wave has arrived at or passed through the predetermined point are predicted based on the property of the tsunami or the sea wave.

(Supplementary Note 15)

The event identification method according to Supplementary Note 14, wherein
in the identification step,
prediction results of the time when the tsunami or the sea wave arrives at or passes through the predetermined point, and the wave height when the tsunami or the sea wave has arrived at or passed through the predetermined point are notified to a predetermined notification destination.

(Supplementary Note 16)

The event identification method according to Supplementary Note 14 or 15, wherein
in the identification step,
possibility that the tsunami or the sea wave causes damage at the predetermined point is estimated based on the property of the tsunami or the sea wave, and when there is a possibility of causing damage, a level of damage is further estimated.

(Supplementary Note 17)

The event identification method according to Supplementary Note 16, wherein
in the identification step,
estimation results of possibility that the tsunami or the sea wave causes damage to the predetermined point, and when there is a possibility of causing damage, the level of damage are notified to a predetermined notification destination.

(Supplementary Note 18)

The event identification method according to Supplementary Note 13, wherein
in the identification step,
when movement of a ship is identified as an event that has occurred in the observation region,
a state of the ship is identified based on detection results of distribution of water pressure and time fluctuation of water pressure in the observation region, and
it is detected that the ship has invaded a predetermined region or may possibly invade the predetermined region based on the state of the ship.

(Supplementary Note 19)

The event identification method according to Supplementary Note 18, wherein
in the identification step,
position data information of the ship is wirelessly received, and
the ship that has invaded the predetermined region, or the ship that may possibly invade the predetermined region is identified based on the position data information.

(Supplementary Note 20)

The event identification method according to Supplementary Note 18 or 19, wherein
in the identification step,
when it is detected that the ship has invaded a predetermined region, or may possibly invade the predetermined region, the detection result is notified to a predetermined notification destination.

(Supplementary Note 21)

The event identification method according to Supplementary Note 13, wherein
in the identification step,
when a tide is identified as an event that has occurred in the observation region,
it is detected that a high tide or a rapid tide is occurring in the observation region, based on a pattern of the light signal.

(Supplementary Note 22)

The event identification method according to Supplementary Note 21, wherein
in the identification step,
when it is detected that a high tide or a rapid tide is occurring in the observation region, the detection result is notified to a predetermined notification destination.

(Supplementary Note 23)

The event identification method according to any one of Supplementary Notes 13 to 22, wherein
in the identification step,
water depth in the observation region is detected based on a pattern of the light signal.

(Supplementary Note 24)

The event identification method according to Supplementary Note 23, wherein
in the identification step,
change of water depth in the predetermined region is detected by detecting water depth in the observation region regularly or irregularly.

This application claims priority on the basis of Japanese Patent Application No. 2019-191494 filed on Oct. 18, 2019, which is herein incorporated in its entirety.

### REFERENCE SIGNS LIST

10 OPTICAL FIBER CABLE
11 OPTICAL FIBER
20 RECEPTION UNIT
30 IDENTIFICATION UNIT
40 COMPUTER
41 PROCESSOR
42 MEMORY
43 STORAGE
44 INPUT/OUTPUT INTERFACE
441 DISPLAY APPARATUS
442 INPUT APPARATUS
443 SOUND OUTPUT APPARATUS
45 COMMUNICATION INTERFACE

What is claimed is:

1. An optical fiber sensing system, comprising:
an optical fiber configured to sense water pressure change caused by an event that has occurred in an observation region, the optical fiber being disposed in water;
a reception unit configured to receive a light signal from the optical fiber; and
an identification unit configured to detect distribution of water pressure and time fluctuation of water pressure in the observation region based on a pattern of the light signal, and to identify an event that has occurred in the observation region based on the detection result.

2. The optical fiber sensing system according to claim 1, wherein
when identifying a tsunami or a sea wave as an event that has occurred in the observation region,
the identification unit
identifies a property of the tsunami or the sea wave based on detection results of distribution of water pressure and time fluctuation of water pressure in the observation region, and
predicts the time when the tsunami or the sea wave arrives at or passes through a predetermined point and the wave height when the tsunami or the sea wave has arrived at or passed through the predetermined point based on the property of the tsunami or the sea wave.

3. The optical fiber sensing system according to claim 2, wherein
the identification unit
notifies prediction results of the time when the tsunami or the sea wave arrives at or passes through the predetermined point, and the wave height when the tsunami or the sea wave has arrived at or passed through the predetermined point, to a predetermined notification destination.

4. The optical fiber sensing system according to claim 2, wherein
the identification unit
estimates possibility that the tsunami or the sea wave causes damage at the predetermined point based on the property of the tsunami or the sea wave, and when there is a possibility of causing damage, further estimates a level of damage.

5. The optical fiber sensing system according to claim 4, wherein
the identification unit
notifies estimation results of a possibility that the tsunami or the sea wave causes damage to the predetermined point, and the level of damage when there is a possibility of causing damage, to a predetermined notification destination.

6. The optical fiber sensing system according to claim 1, wherein
when identifying movement of a ship as an event that has occurred in the observation region,
the identification unit
identifies a state of the ship based on detection results of distribution of water pressure and time fluctuation of water pressure in the observation region, and
detects that the ship has invaded a predetermined region or may possibly invade the predetermined region based on the state of the ship.

7. The optical fiber sensing system according to claim 6, wherein
the identification unit
wirelessly receives position data information of the ship, and
identifies the ship that has invaded the predetermined region, or the ship that may possibly invade the predetermined region, based on the position data information.

8. The optical fiber sensing system according to claim 6, wherein
when detecting that the ship has invaded a predetermined region, or may possibly invade the predetermined region,
the identification unit notifies the detection result to a predetermined notification destination.

9. The optical fiber sensing system according to claim 1, wherein
when identifying a tide as an event that has occurred in the observation region,
the identification unit detects that a high tide or a rapid tide is occurring in the observation region based on a pattern of the light signal.

10. The optical fiber sensing system according to claim 9, wherein
when detecting that a high tide or a rapid type is occurring in the observation region,
the identification unit notifies the detection result to a predetermined notification destination.

11. The optical fiber sensing system according to claim 1 wherein
the identification unit detects water depth in the observation region based on a pattern of the light signal.

12. The optical fiber sensing system according to claim 11, wherein
the identification unit detects change of water depth in the predetermined region by detecting water depth in the observation region regularly or irregularly.

13. An event identification method by an optical fiber sensing system, the event identification method comprising:
a reception step of receiving a light signal from an optical fiber configured to sense water pressure change caused by an event that has occurred in an observation region, the optical fiber being disposed in water; and
an identification step of detecting distribution of water pressure and time fluctuation of water pressure in the observation region based on a pattern of the light signal, and identifying an event that has occurred in the observation region based on the detection result.

14. The event identification method according to claim 13, wherein
in the identification step,
when a tsunami or a sea wave is identified as an event that has occurred in the observation region,
a property of the tsunami or the sea wave is identified based on detection results of distribution of water pressure and time fluctuation of water pressure in the observation region, and
time when the tsunami or the sea wave arrives at or passes through a predetermined point, and wave height when the tsunami or the sea wave has arrived at or passed through the predetermined point are predicted based on the property of the tsunami or the sea wave.

15. (canceled)

16. The event identification method according to claim 14, wherein
in the identification step,
possibility that the tsunami or the sea wave causes damage at the predetermined point is estimated based on the property of the tsunami or the sea wave, and when there is a possibility of causing damage, a level of damage is further estimated.

17. (canceled)

18. The event identification method according to claim 13, wherein
in the identification step,
when movement of a ship is identified as an event that has occurred in the observation region,
a state of the ship is identified based on detection results of distribution of water pressure and time fluctuation of water pressure in the observation region, and
it is detected that the ship has invaded a predetermined region or may possibly invade the predetermined region based on the state of the ship.

19. The event identification method according to claim 18, wherein
in the identification step,
position data information of the ship is wirelessly received, and
the ship that has invaded the predetermined region, or the ship that may possibly invade the predetermined region is identified based on the position data information.

20. (canceled)

21. The event identification method according to claim 13, wherein
in the identification step,
when a tide is identified as an event that has occurred in the observation region,
it is detected that a high tide or a rapid tide is occurring in the observation region, based on a pattern of the light signal.

22. (canceled)

23. The event identification method according to claim 13, wherein
in the identification step,
water depth in the observation region is detected based on a pattern of the light signal.

24. The event identification method according to claim 23, wherein
in the identification step,
change of water depth in the predetermined region is detected by detecting water depth in the observation region regularly or irregularly.
